(19) United States
(12) Patent Application Publication
(10) Pub. No.: US 2007/0208665 A1
(43) Pub. Date: Sep. 6, 2007

(54) Electronic document creating device, storage medium storing electronic document creating program, electronic document creating method, and storage medium storing electronic form

(76) Inventor: Hiromi Ohara, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/454,504

(22) Filed: Jun. 16, 2006

(30) Foreign Application Priority Data
Mar. 2, 2006 (JP) 2006-056100

(51) Int. Cl. G06Q 99/00

(52) U.S. Cl. 705/51

(57) ABSTRACT

There is provided an electronic document creating device that creates a new electronic document. The electronic document creating device includes an obtaining unit, an assigning unit, and a prevention processing unit. The obtaining unit obtains an electronic form containing one or a plurality of variable fields, to each of which a value is to be assigned, and further containing permission information specifying user operation permission with respect to a value to be assigned to each of the variable fields. The assigning unit assigns a value to each of the variable fields in the electronic form. The prevention processing unit performs processing to prevent operation by a user who has no permission, based on the permission information, with respect to the value assigned to each of the variable fields.

### PRIORITY INFORMATION

This application claims priority to Japanese Patent Application No. 2006-56100 filed on Mar. 2, 2006, which is incorporated herein by reference in its entirety.

### BACKGROUND

1. Technical Field

The present invention relates to a technique for creating electronic documents, and, more particularly, to a technique for ensuring security of the created electronic documents.

2. Related Art

A technique for managing electronic documents using a security policy that specifies user operation permissions (such as reading, writing, copying, and printing permissions) is known in the art. FIG. 12 is a diagram for illustrating an outline of this technique, and shows a state of processing performed among an electronic document creator 200 who creates an electronic document, a policy management server 202 that manages a security policy, an electronic document user 204 who uses the created electronic document, and a user authentication server 206 that authenticates the user.

First, the electronic document creator 200 creates a new electronic document 208 (S500). A security policy to be assigned to this electronic document 208 is either selected from among security policies registered in the policy management server 202, or is newly created to be registered in the policy management server 202 in association with the electronic document 208 (S502). The created electronic document 208 is delivered to the electronic document user 204 by means of electronic mail transmission, downloading, or other means (S504). However, because an electronic document 210 to be delivered is associated with the security policy registered in the policy management server 202, the electronic document 210 is locked with a “key” for access restriction purposes. To allow the electronic document user 204 to access the delivered electronic document 210, first, user authentication is performed by the user authentication server 206 (S506). Next, operation permission is verified through an inquiry to the policy management server 202 (S508). Thus, the electronic document user 204 is allowed to use the electronic document 210 so long as the user has a predetermined type of permission.

In the above-described technique, because the electronic document and the security policy are managed separately, the security policy can be changed on the side of the manager even after the electronic document has been distributed. In other words, it is possible to manage what operation may be performed on which electronic document, and when and by whom it may be performed. However, because this technique requires that the user set the security policy at the time of creating the electronic document, there is a possibility that an appropriate security policy cannot be set. In addition, this technique has a problem in that the burden imposed on the user is increased, especially when a large amount of electronic documents are to be created.

### SUMMARY

According to one aspect of the present invention, there is provided an electronic document creating device that creates a new electronic document, the device comprising an obtaining unit that obtains an electronic form containing one or a plurality of variable fields, to each of which a value is to be assigned, and further containing permission information specifying user operation permission with respect to a value to be assigned to each of the variable fields; an assigning unit that assigns a value to each of the variable fields in the electronic form; and a prevention processing unit that performs processing to prevent operation by a user who has no permission, based on the permission information, with respect to the value assigned to each of the variable fields.

### BRIEF DESCRIPTION OF THE DRAWINGS

Embodiments of the present invention will be described in detail based on the following figures, wherein:

FIG. 1 is a diagram showing an outline of an example structure of an electronic document management system;

FIG. 2 is a diagram showing an outline of an example structure of a process server;

FIG. 3 is a sequence diagram showing an example operation of the electronic document management system;

FIG. 4 is a flowchart illustrating user operation performed during creation of an electronic document;

FIG. 5 is a flowchart illustrating system processing performed during creation of an electronic document;

FIG. 6 is a flowchart illustrating system processing performed during viewing of an electronic document;

FIG. 7 is a diagram showing an example of a template form;

FIG. 8 is a diagram showing an example of metadata embedded in the template form;

FIG. 9 is a diagram showing an example of an encryption process performed when an electronic document is created from the template form;

FIG. 10 is a diagram showing an example of metadata embedded in the electronic document;

FIG. 11 is a diagram showing an example of display provided when a user views the electronic document; and

FIG. 12 is a diagram illustrating a related art policy management server.

### DETAILED DESCRIPTION

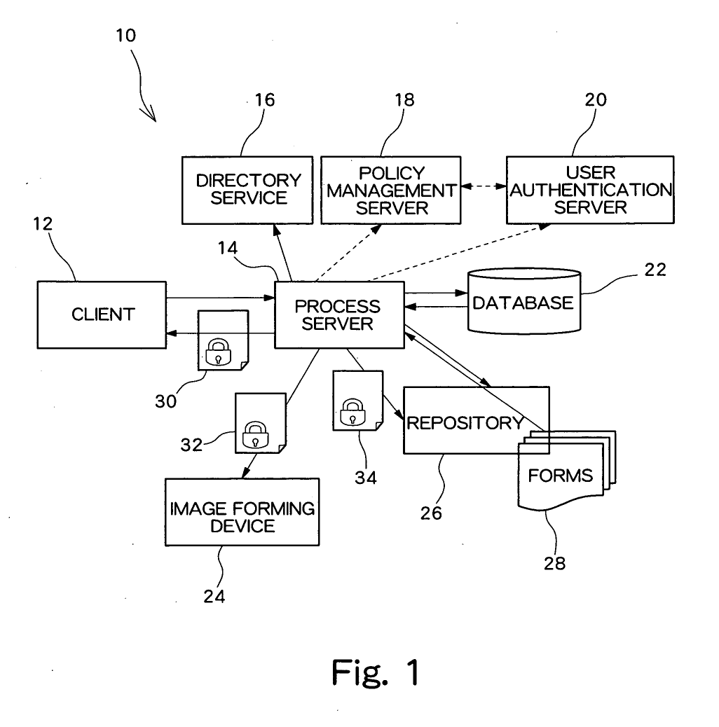

FIG. 1 is a diagram illustrating a schematic structure of an electronic document management system 10 according to an exemplary embodiment of the present invention. The electronic document management system 10 includes a client 12, a process server 14, a directory service 16, a policy management server 18, a user authentication server 20, a database 22, an image forming device 24, and a repository 26.

The client 12 is a terminal device used by a user. In accordance with an instruction from the user, the client 12 requests the process server 14 to create, store, print, or otherwise process an electronic document on demand. The client 12 may be a PC (personal computer) or a multifunction device (a device having a plurality of image processing functions, such as a printer function, a scanner function, and the like), or may be constructed from various devices connected to a network.

The process server 14 is a device that serves as a central device for control and processing of this system, and is constructed from a PC, an image forming device, or the like. The process server 14 causes each constituent component of this system to perform a process for executing a request input from the client 12, and itself also creates an electronic document. For example, the process server 14 creates an electronic document by combining a form 28 obtained from the repository 26 and information retrieved from the database 22. Further, the process server 14 transmits the created electronic document to the client 12, causes the image forming device 24 to print the document, stores the document in the repository 26, and performs other processes. In order to verify the validity of access from the client 12, the process server 14 accesses the user authentication server 20 to authenticate the user. Further, the process server 14 accesses the policy management server 18 to register or verify the security policy of an electronic document, accesses the directory service 16 to obtain a public key certificate (or a public key included therein) to perform encryption and decryption on fields of the electronic document, and performs other tasks to ensure necessary security.

The directory service 16 is constructed by a server which manages user information using an LDAP (lightweight directory access protocol) or the like, and performs a service to provide the user information in response to an inquiry. The user information managed by the directory service 16 may include user's general information, such as a user name, a group to which the user belongs, and contact information, and may also include public key information based on a public key encryption scheme, and the like.

The policy management server 18 is a device that stores a security policy associated with an electronic document. The user authentication server 20 is a server for authenticating a user who attempts to access the system, on the basis of an authentication system, such as a public key encryption scheme or the like. The database 22 stores various types of data, such as characters, numeric values, images, sounds, and the like.

The image forming device 24 is a device which is constructed from a printer, a multifunction device, or the like, and prints an electronic document in response to an instruction from the process server 14. The repository 26 stores an electronic document created in accordance with a user request, and stores a form 28, which is template data to be used for creating an electronic document.

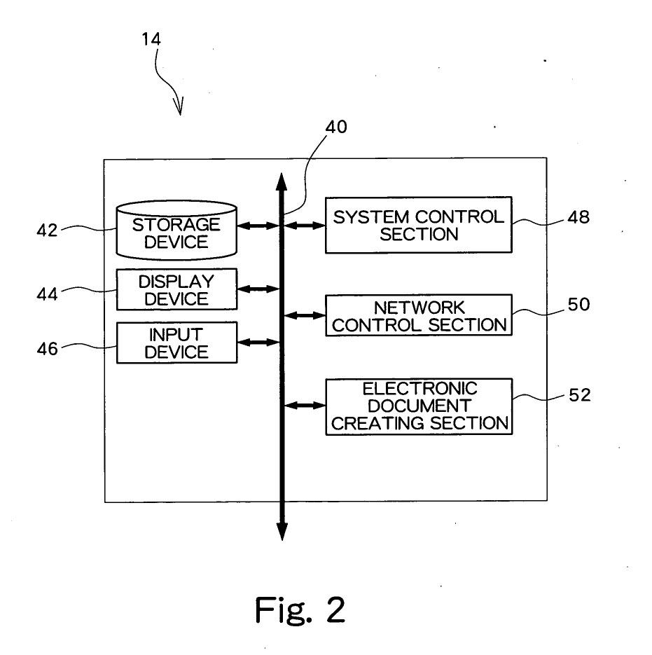

FIG. 2 is a diagram illustrating an example structure of the process server 14. The process server 14 includes a network 40 that performs data transfer between internal devices, and to and from external devices. The network 40 has connected thereto a storage device 42, a display device 44, an input device 46, a system control section 48, a network control section 50, and an electronic document creating section 52.

The storage device 42 is a device which is constructed from a semiconductor memory, a hard disk, or the like, and stores an electronic document, a program, and the like for a short or long period of time. The display device 44 is constructed from a liquid crystal display, a CRT, or the like, and displays an electronic document, the content of an instruction, and the like. The input device 46 is constructed from a keyboard, a touch panel, or the like, and receives an instruction from a user. The input device 46 may also serve as the client 12 shown in FIG. 1. The system control section 48 receives an instruction input from a user through the input device 46, or over the network 40, and controls operation of each constituent component of the process server 14. The network control section 50 controls the time at which data is transferred to the network 40, and the like. The electronic document creating section 52 creates a new electronic document using a form 28 as shown in FIG. 1. For creation of an electronic document, necessary security settings are performed. It should be noted that the process server 14 further includes the capability of controlling operation on the basis of the security settings in cases such as a case where a created electronic document is later downloaded by another user, and other capabilities.

The constituent components of the electronic document management system 10 as shown in FIGS. 1 and 2 may be implemented in various manners. For example, it is possible to construct the electronic document management system 10 from a single high-performance multifunction device, and it is also possible to construct the electronic document management system 10 from a directly-connected or network-connected PC, multifunction device, or the like. In addition, it is also possible to distribute any constituent component among a plurality of devices by, for example, providing the repository 26 in storage devices in a plurality of devices in a distributed manner.

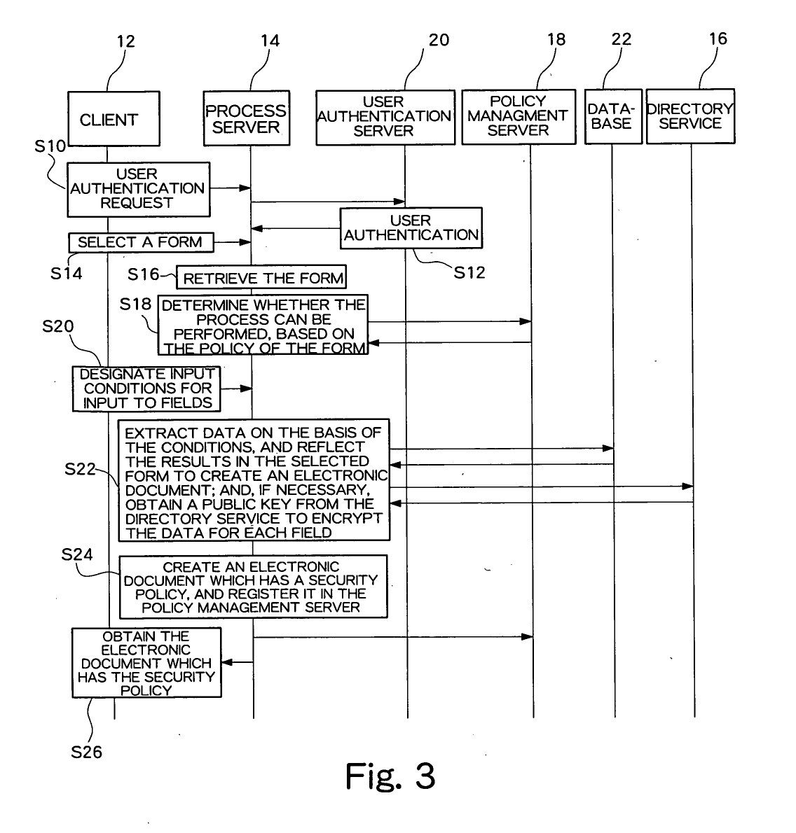

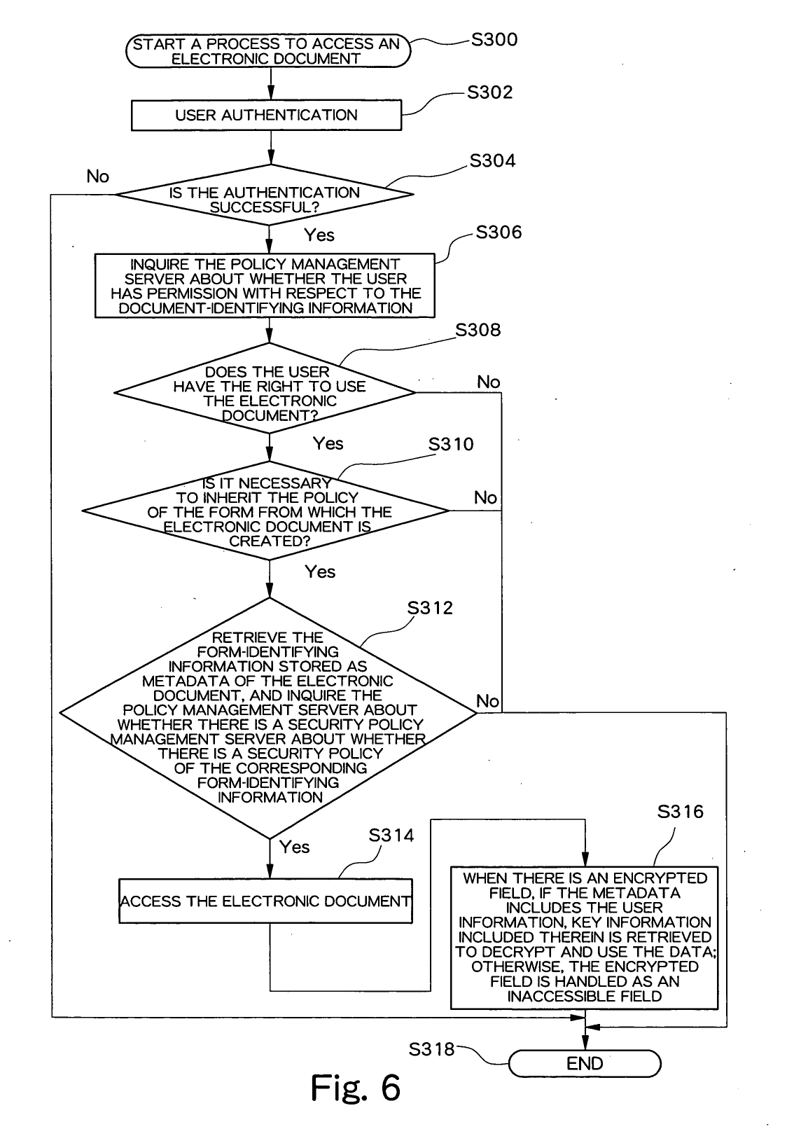

Next, operation of the electronic document management system 10 as shown in FIG. 1 will be described with reference to FIGS. 3 through 6. The electronic document management system 10 functions as an electronic document creating device for creating a new electronic document on the basis of a template form, and also functions as an electronic document management device for managing access to the created new electronic document. In the following description, a process of creation of an electronic document will be described with reference to FIGS. 3 through 5, and a process of management of an electronic document will be described with reference to FIG. 6.

FIG. 3 is a sequence diagram illustrating a process of creating an electronic document on the basis of a template form in the electronic document management system 10. In this diagram, the flow of the processing is shown separately for each of the client 12, the process server 14, the user authentication server 20, the policy management server 18, the database 22, and the directory service 16.

To access the process server 14, the client 12 receives user authentication (SlO). Specifically, first, a user name and other information are transmitted from the client 12 to the process server 14, and then the process server 14 issues a request for authentication to the user authentication server 20. The user authentication server 20 performs verification for authentication, and responds to the process server 14 with the results of the verification and relevant user information (S12). Then, an operation of creating an electronic document is started, and information regarding a form to be selected is transmitted from the client 12 to the process server 14 (S14). The process server 14 retrieves this form from the repository 26 (S16), and asks the policy management server 18 whether or not the user has permission to create a new electronic document on the basis of this form (S18). The policy management server 18 investigates the security policy stored therein to determine whether the user has the permission, and when the user has the permission, the policy management server 18 transmits a response indicating so, and including data, such as data for using a key to be set for the electronic document (such a key can be achieved by, for example, setting a password, or through encryption).

Then, conditions for assigning a value to each field of the form are input from the client 12 to the process server 14 (S20). The process server 14 extracts data from the database 22 on the basis of the input conditions, and assigns the resultant data to the fields of the selected form to create an electronic document (S22). In addition, when a user who is permitted to view each of the fields of the created electronic document is set for the original form, a public key for that user is obtained from the directory service 16 to encrypt the assigned values (S22). The process server 14 then embeds identifying information into the created electronic document, and creates, under a name identified by the identifying information, a security policy whose settings are inherited from the security policy which is set for the original form to thereby set the created security policy in the policy management server 18 (S24). In other words, the security policy set for the created electronic document is set with reference to the security policy of the form which is used as a template, so as to incorporate therein the settings of the template form. Further, a key for ensuring security corresponding to the security policy is set as needed for the overall electronic document. Thus, the electronic document, for which the security policy with the same settings as those set for the original form is set, is created and output to-the client 12 (S26). It is to be understood that the electronic document may be transmitted to a third party via e-mail, stored in a repository, or printed by an image forming device.

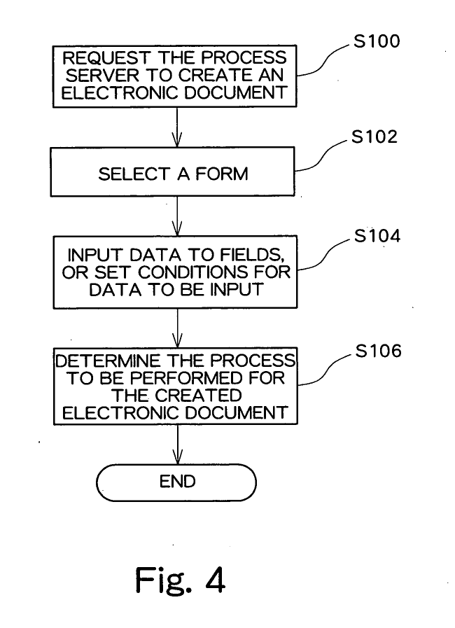

Next, the flow of execution of user instructions in the process illustrated in FIG. 3 will be reviewed with reference to the flowchart shown in FIG. 4. Through the client 12, the user requests the process server 14 to create an electronic document (SlOO), and selects a desired form from among prepared forms (S102). Then, data is directly input to fields of the form, or, alternatively, various conditions for input based on the database are set (S104). As a result, an electronic document is created, and, for this created electronic document, a security policy whose settings are inherited from the security policy of the selected form is set. Further, when security settings for assigned data are predefined for the fields of the form, corresponding processing such as encryption or addition of an electronic signature is automatically performed. For such processing, it is not necessary for the user to issue a particular instruction. Subsequently, when the user wishes to further process the created electronic document in some way, an instruction specifying the process is provided to the process server 14 (S106). For example, when the user wishes to print the electronic document, a print instruction is set to specify an image forming device to which the electronic document is to be transmitted, and the print instruction is provided to the process server 14. Further, when the user wishes to store the electronic document in a repository, the repository 26 in which the electronic document is to be stored is selected, and a request is made to the process server 14. When the user wishes to transmit the electronic document via e-mail, the recipient address is designated, and a request is made to the process server 14.

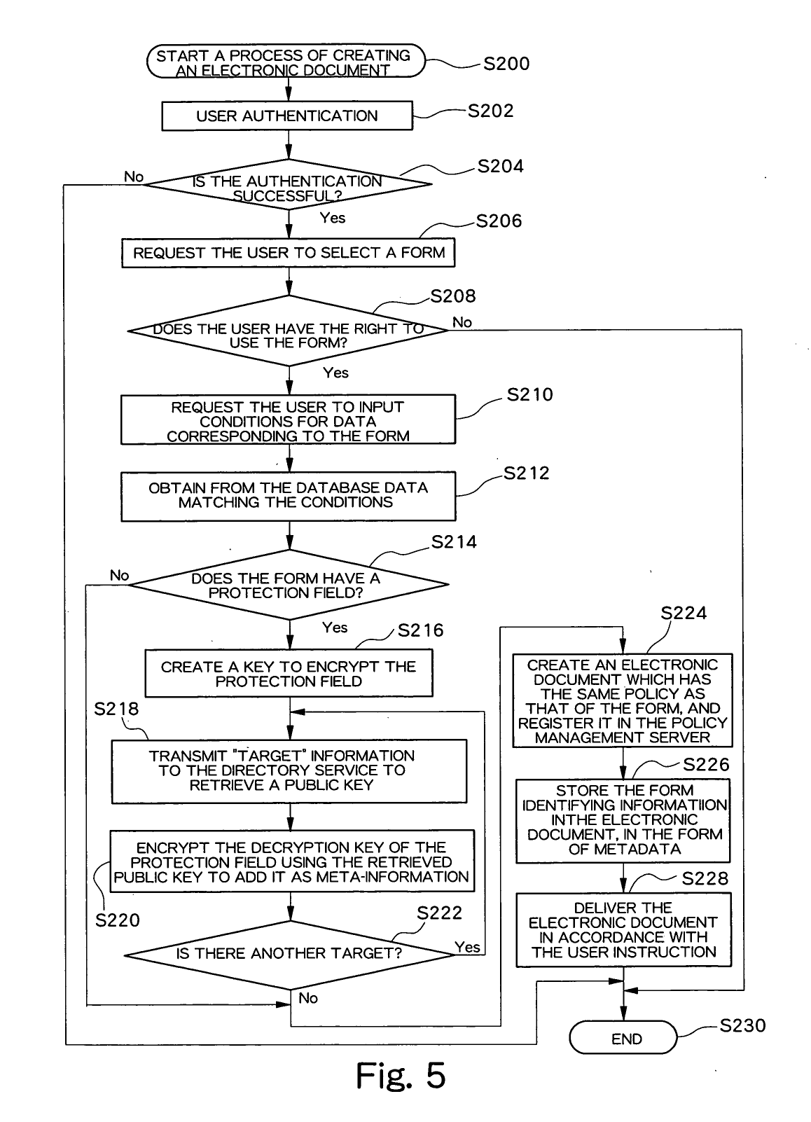

The flowchart in FIG. 5 illustrates the flow of system-side processing steps performed in the process shown in FIG. 3. After the process of creating an electronic document is started (S200), first, the user authentication server 20 authenticates the user (S202, S204). When the user cannot be authenticated, the process ends (S230), and when the user can be authenticated, the user is requested to select a form to be used (S206). After a form is selected, reference is made to the security policy registered in the policy management server 18 so as to determine whether or not the user has permission to use the form (S208). When the user does not have the permission, the process ends (S230), and when the user has the permission, the user is requested to set conditions for input of data to fields of the form (S210). Data matching the conditions is obtained from the database 22, and is assigned to the fields (S212). Subsequently, reference is made to metadata of the form so as to determine whether or not each field of the form is a protection field, or, more specifically, whether or not the field is a field in which input data is to be protected (S214). When protection is set for a field, a key for encrypting the field is set (S216). Specifically, information regarding a user (referred to as “target”) who is permitted to view the field is transmitted to the directory service 16, and a public key of this user is retrieved (S218). Then, the retrieved public key is used to encrypt the field, and the public key is embedded in the electronic document as meta-information (S220). When there is another user who is permitted to view the field, the process repeats the operations of steps S218 and S220.

Then, a security policy of the created electronic document is registered in the policy management server 18 (S224). Typically, the same security policy as that set for the template form is used as the security policy to be registered. For registration, identifying information for association with the security policy is stored in the electronic document in the form of metadata, and this identifying information is also clearly presented in the registered security policy. Thus, the electronic document and the security policy are associated with each other. In addition, a key for ensuring security specified by the security policy is locked as needed for the overall electronic document. An exemplary embodiment is taken as one example in which the overall electronic document is encrypted by use of a password, and a user who does not know the password is prevented from viewing the electronic document. Instead of newly assigning to the electronic document the same security policy as that of the form, it is also possible to provide a mechanism for referring to the security policy of the form to inherit the settings thereof. For example, form identifying information for identifying the original form is stored in the electronic document in the form of metadata (S226). Thus, it is possible to refer to the security policy corresponding to this form identifying information to inherit the settings thereof. Further, instead of setting the form identifying information for the electronic document, a mechanism for referring to the security policy of the form to inherit the settings thereof may be set for the registered security policy. In the end, the electronic document is delivered or otherwise handled in accordance with a user instruction (S228).

The flowchart in FIG. 6 illustrates the process performed when a created electronic document is used. When access to the electronic document is attempted (S300), first, the user authentication server 20 authenticates the user (S302, S304). As a consequence, when authentication has failed, the process ends (S318), and when authentication is successful, an inquiry is made to the policy management server 18 as to whether or not the user has permission regarding this electronic document (S306). Specifically, the policy management server 18 investigates the security policy corresponding to the identifying information embedded in the electronic document to verify whether or not the user has operation permission for use in a manner in which the user intends to use the electronic document (S308). When the user has the permission, a determination is made as to whether or not the settings are set to inherit those of the security policy of the form used for creation of the electronic document (S310). When the settings are set to inherit, the form-identifying information stored as metadata of the electronic document is retrieved, to thereby inquire the policy management server whether or not there is a security policy which has corresponding form-identifying information (S312). When there is a security policy corresponding to the form-identifying information, access to the electronic document (such as reading or other operation) is performed in accordance with operation permission granted by this security policy (S314).

For access, a state of encryption is confirmed for each field with reference to metadata of the electronic document. Then, when there is an encrypted field, key information or the like specifying which public key is used to encrypt the field is retrieved from the metadata, and is interpreted to perform processing, such as decryption using that public key or the like. When the encrypted field cannot be decrypted, the encrypted field is handled as a field which cannot be accessed (S316)

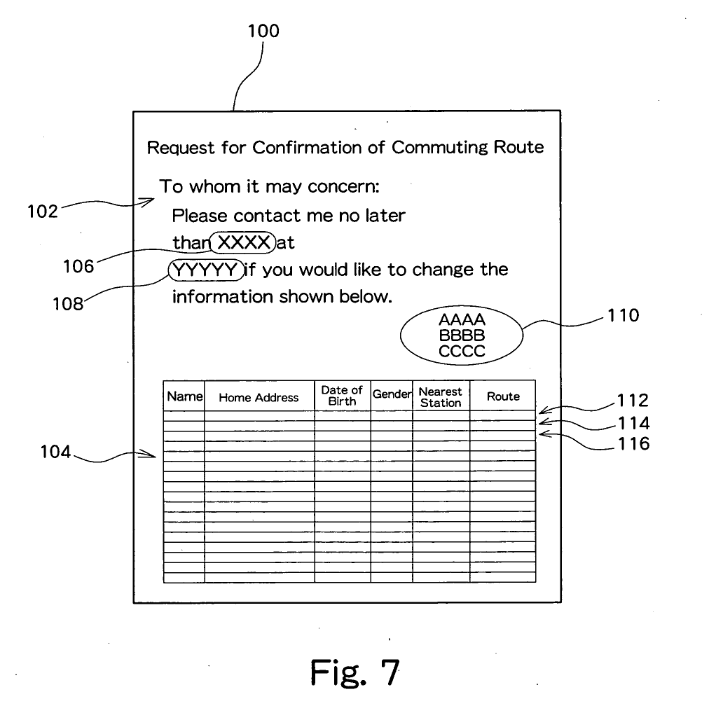

Next, the processes for creating and viewing an electronic document will be specifically described below with reference to FIGS. 7 through 11.

FIG. 7 is a diagram showing an-example of an electronic form 100 represented in the form of a print image. The form 100 as shown therein is template data for use in creation of a “Request for Confirmation of Commuting Route” for asking a worker to confirm a commuting route between home and work. Typical text 102 and a table 104 are preset in this form 100. The text 102 and the table 104 include therein a plurality of variable fields, to each of which a value is to be assigned in the process of creating an electronic document. Specifically, the text 102 includes a date field 106 for entry of a deadline date “XXXX,” and an address field 108 for entry of a reply address “YYYYY,” and also includes a section 110 which is to be filled in by a document creator, and in which there are provided variable fields for entry of a creation date, “AAAA,” the division to which the creator belongs, “BBBB,” and the name of the creator, “CCCC.” A date and other information corresponding to the actual creation of an electronic document are entered into these variable fields. Further, the table 104 has entry sections 112, 114, 116 . . . ; each section includes variable fields for listing a worker's “Name,” “Home Address,” “Date of Birth,” “Gender,” “Nearest Station,” and “Route.” A staff member responsible for general affairs in the company creates a “Request for Confirmation of Commuting Route” by associating, with each field, appropriate data obtained from the database that registers personal information of the workers, to assign a value to each field.

The created Request for Confirmation of Commuting Route is delivered to each worker, and is verified as to whether or not the entered data is appropriate. However, because the data entered into the variable fields in the table 104 is personal information, such information is desirably hidden from third parties. In one possible approach to this end, an electronic document to be delivered is not data having sections for a plurality of workers, but only includes information entered in connection with one worker who is expected to receive the document. However, by performing security settings as will be described below, it is possible to achieve protection of personal information entered in each variable field.

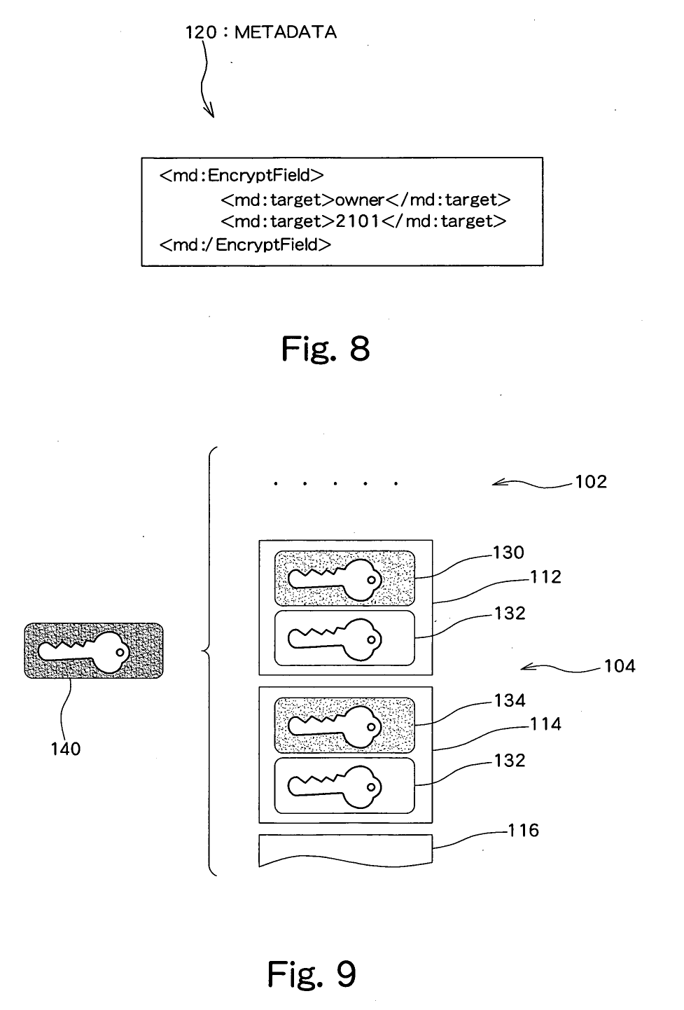

FIG. 8 is a diagram illustrating an example of metadata 120 to be embedded in the form 100 shown in FIG. 7. In this example, the metadata 120 is set for each of the entry sections 112, 114, 116 . . . , for each worker listed in the table 104 of the form 100. The metadata 120 is implemented in a markup language, such as XML or the like, and is described with a prefix of “md” indicating that the description is in the form of metadata. In the metadata 120, encryption instructing information is described between tags of “<md:EncryptField>” indicating fields that are to be encrypted. Specifically, a user who is able to view information assigned to the fields is set as a “target” between these tags. In the example shown in FIG. 8, “owner” representing a worker whose information is to be entered into the fields and “2101” representing a user ID of a manager in the general affairs division who creates an electronic document are set as targets.

FIG. 9 is a diagram schematically showing a state in which the text 102 and the table 104 of the form 100 shown in FIG. 7 are encrypted on the basis of the metadata 120 shown in FIG. 8, or the like. In this example, the entry sections 112, 114, 116 . . . , in the table 104 are each encrypted by two public keys. Specifically, the entry section 112 is encrypted by a public key 130 of a target person (for example, “Mr. Smith”) whose information is to be entered in this section, which corresponds to the “owner” target shown in FIG. 8, and, in addition to this encryption, the entry section 112 is also encrypted by a public key 132 of the general affairs staff, which corresponds to the target “2101” shown in FIG. 8. Resultant data obtained by encryption using the public keys 130 and 132 can be decrypted only by Mr. Smith and the general affairs staff who each have a corresponding private key. Similarly, the entry section 114 is encrypted separately by a public key 134 of a target person whose information is to be entered in this section, and by the public key 132 of the general affairs staff. In addition, the table 104 thus encrypted and the text 102 not encrypted are both encrypted by a public key 140 in accordance with the security policy set for the overall electronic document. This key 140 may be, for example, a password which is made known only to workers in this company, or may also be an appropriate public key.

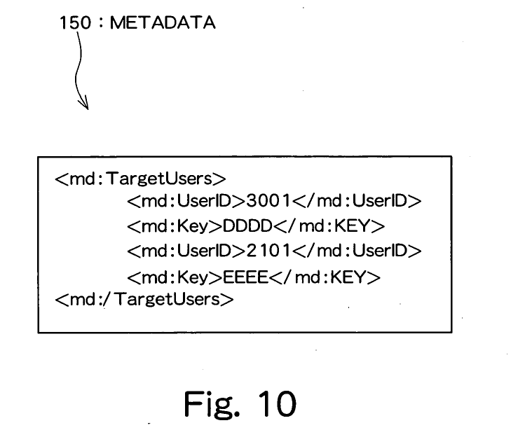

FIG. 10 shows an example of metadata 150 which is to be embedded in the created electronic document after the encryption shown in FIG. 9 is performed. This metadata 150 is set for the variable fields of the entry sections 112, 114, 116 . . . , to correspond to the metadata 120 shown in FIG. 8. In this example, descriptions are provided between tags of “TargetUsers” to indicate that “UserID” is 3001 and “Key” is DDDD, and to indicate that “UserID” is 2101 and “Key” is EEEE. In other words, Mr. Smith's user ID, “3001,” and his public key 130, “DDDD,” are written to correspond to the “owner” target in the metadata 120, and the general affairs staff member's user ID, “2101,” and his or her public key 132, “EEEE,” are written to correspond to the “2101” target in the metadata 120. By investigating the metadata 150, a user who later accesses the electronic document can ascertain whether or not each variable field is encrypted, as well as who has permission to view the electronic document.

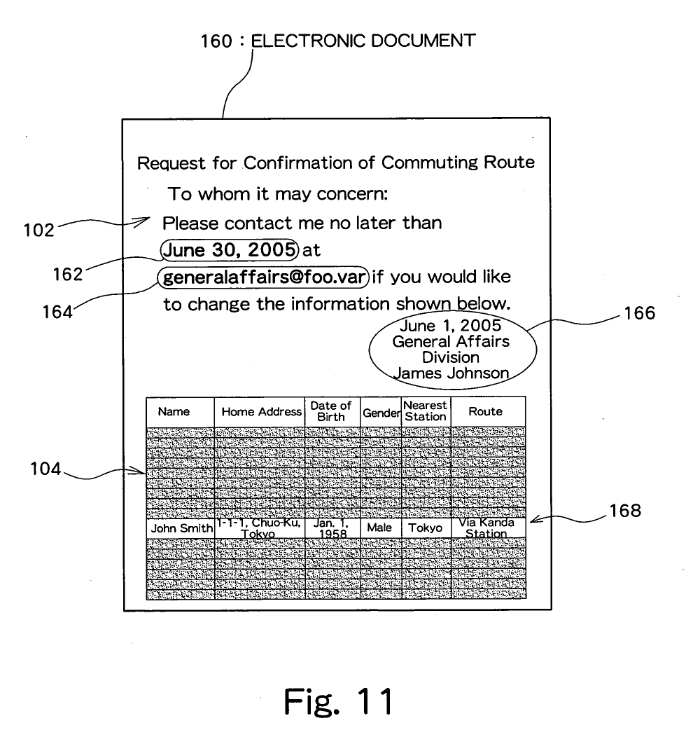

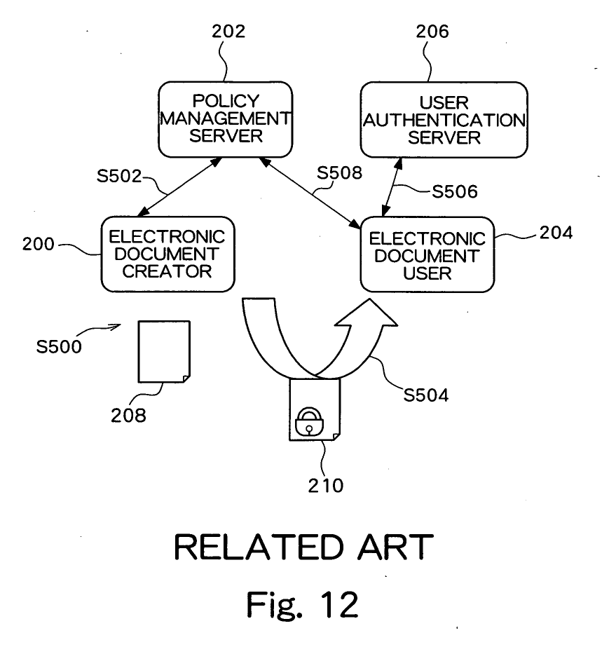

FIG. 11 is an image diagram showing a case where one of the workers, Mr. Smith, views an electronic document 160 which is created by assigning values to the form 100 shown in FIG. 7, and through encryption. The electronic document 160 includes the text 102 and the table 104, as in the form 100. However, in the text 102, a date field 162 shows “June 30, 2005,” an address field 164 shows “generalaffairs@foo.var,” and a creator section 166 shows “Jun. 1, 2005,” “General Affairs Division,” and “James Johnson.” These fields are not protected by encryption, and therefore the values therein are shown.

In the table 104, only a section 168 is shown, and the other sections are hidden by black coloring. This is because the viewer, Mr. Smith, is the owner of information contained in the section 168, and, although he can decrypt this section 168, he does not have permission to view other fields, and cannot decrypt other fields. By means of this view, Mr. Smith can confirm his own commuting route, and can change the route if necessary. On the other hand, personal information of other workers is kept secret from Mr. Smith. Further, a similar situation applies to cases where Mr. Smith prints out the electronic document, or forwards the file, in a sense that the encryption cannot be decrypted, and the other workers' personal information will not be revealed. It is to be understood that when the general affairs staff member downloads, prints out, forwards, or otherwise uses this Request for Confirmation of Commuting Route, information of all workers is decrypted by his private key.

In the above description, settings for protecting home addresses and other personal information are described by taking as an example a Request for Confirmation of Commuting Route. With respect to an electronic document containing secret information of a plurality of people or organizations as in the above-described example, the above-described exemplary embodiment wherein operation permission is set for each variable field to ensure security of the secret information is advantageous. This embodiment is also advantageous in cases where secret information of a certain person or organization, such as that contained in a patient's medical record, is to be selectively disclosed to a plurality of people. For example, for the case of medical records, operation permissions may be set such that all fields may be set to be able to be viewed by doctors and nurses, such that fields for a name of disease and the like may be set to be unable to be viewed by accounting clerks, and such that all fields may be set to be unable to be viewed by third parties.

In the following description, various exemplary embodiments of the present invention will be summarized. Some of the exemplary embodiments may have been already described above, but will be described again here.

According to one aspect of the present invention, the term “electronic form” refers to electronic data that defines a format. In other words, the electronic form is an original electronic document for use as a template in creating an electronic document, and which may also be referred to as “format data,” “form data,” “form,” or the like. Here, the term “electronic document” is a document represented by electronic data. The term “document” generally refers to a wide variety of documents, including those with characters, and those with a table or image. Formats defined by electronic forms are not limited to particular types of formats, and are intended to cover various types of objects, such as document text, table setting, layout, and the like.

The term “variable field” represents one or more areas that are provided in an electronic form; values are assigned to these fields in the process of creating an individual electronic document. Values to be assigned to the variable fields may be characters (such as, for example, names, addresses, names of goods, and URLs), numeric values (such as, for example, dates, quantities, and prices), images (such as, for example, photos of faces, and photos of goods), audio data, and the like. It should be noted that in addition to such variable fields, an electronic form usually includes an area which can be called a “fixed field.” The fixed field has set therein formats for characters, layout, and the like that are to be set in common for electronic documents to be created therefrom.

Permission information is information for managing operation permission with respect to a value assigned to a variable field in the course of creation of an electronic document. The term “operation permission” refers to information specifying whether or not the value can be processed by a user (including a user group). Specifically, permissions such as for downloading (reading and displaying), rewriting (changing), electronic copying, printing on a paper medium, transmission to an external device or an external user, and the like of the value can be exemplified. Among these, downloading is a basic process performed in order to implement various operations, and therefore an advantage achieved by managing downloading permission is significant. It is to be understood that the permission information is set in an electronic form, in the form of metadata or the like of the electronic form.

When this electronic form is used, security protection of values assigned to the variable fields can be easily achieved in creation of an electronic document. More specifically, by setting operation permissions with respect to the variable fields in the created electronic document on the basis of the permission information set for the variable fields, appropriate security settings can be set.

According to one aspect of the present invention, an electronic document.creating device includes an assigning unit that assigns a value to each of the variable fields contained in the electronic form, and a prevention processing unit that performs a process based on the permission information to prevent operation by a user who has no permission with respect to the value assigned to each of the variable fields. The electronic document creating device thereby creates a new electronic document on the basis of the electronic form.

This electronic document creating device can be constructed from hardware with computing functions, such as a workstation, a PC, a multifunction device (a device having a plurality of image processing functions such as that of a printer and the like), and software that defines how the hardware operates. The electronic document creating device may be a device constructed from a plurality of hardware components that are physically separated from each other. The assigning unit assigns, to a variable field, a value determined in accordance with an electronic document to be created. The prevention processing unit performs security settings with respect to the value assigned to the variable field. Specifically, the prevention processing unit performs a process on the basis of the permission information, which is set for the variable field in the electronic form, to prevent operation by a user who has no permission. This operation prevention process can be implemented by encryption, digital signature, or other methods. For example, when encryption is to be performed, the encryption may be implemented by use of a public key of a user who has permission, or by use of a password that can be obtained only by a user who has permission. In such cases, although the encryption is typically performed only on a value assigned in a variable field, the encryption may also be performed on, for example, the variable field itself, to which the value is assigned. Further, although the operation prevention process is typically performed in units of a variable field, when a user who has operation permission is common to a plurality of variable fields, the process may be collectively performed on these variable fields. By employing such an electronic document creating device, it becomes possible to easily create an electronic document which reflects operation information set for the variable fields of an electronic form. This advantage is significant, especially when the electronic form includes a large number of variable fields.

According to another aspect of the present invention, the electronic document creating device further includes a setting unit that sets security policy information specifying operation permission for a created electronic document, the security policy information being set in association with the electronic document and separately from the electronic document, wherein the security policy information is set on the basis of security policy information which is associated with the electronic form and specifies operation permission for the electronic form. The term “security policy information” refers to information which specifies operation permission for a corresponding electronic document. Examples of operation permission may include permission for reading, writing, copying, printing, and other direct operations of an electronic document, permission for scanning printed documents, permission for changing security policy information, and the like. The security policy information is set on the basis of security policy information of the electronic form. In other words, at least a part of the security policy information to be set is created so as to reflect at least a part of the security policy information of the electronic form. The thus-created security policy information is associated with the created electronic document, and is set separately from the electronic document. In short, the security policy information is not integrated with the electronic document, and is created separately. Therefore, it is possible to perform separate management through the use of a policy management server, or the like.

With this structure, because security policy information of a new electronic document is created on the basis of security policy information of a template electronic form, it is possible to reduce the burden imposed on a user in setting security policy information. This advantage is significant, especially when a great number of electronic documents are created. In addition, because the security policy information is managed separately from the created electronic document, it is also possible to easily change or otherwise handle the security policy information after the electronic document is distributed.

It is to be noted that the exemplary embodiment of setting security policy information for the created electronic document based on the security policy of the electronic form can be exemplified by an exemplary embodiment of copying a part or all of the security policy information set for the electronic form, and an exemplary embodiment of inheriting a part or all of the security policy information set for the electronic form. The term “inherit” as used herein refers to a concept similar to that used in object oriented programming. More specifically, a part or all of the security policy information of an original electronic document is regarded as a base class, and the security policy information for an electronic document to be created is set as a derived class which refers to the base class. Thus, the security policy information of the original electronic document is directly incorporated as the security policy information of the electronic document to be created. Information to be added to or to be changed from the security policy information of the original electronic document may be set as needed for the security policy information of the electronic document to be created. The manner in which the inheritance is performed may be set in various ways. As an example, there is an exemplary embodiment in which the security policy of the original electronic document is referred to in a security policy of a new electronic document. As an alternative example, there is an exemplary embodiment in which identifying information of the original electronic document is stored in a new electronic document to thereby establish a direct association between the new electronic document and the security policy of the original electronic document. When the inheritance is performed, because the new electronic document is linked to, or associated with, the security policy information of the original electronic document, any changes in the security policy information of the original electronic document will be immediately reflected in the security policy information of the new electronic document. Therefore, by setting “INVALID” for an item in the security policy of an original electronic document, it is also possible to easily perform a collective operation, such as collective invalidation, of various electronic documents created from the original electronic document.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electronic document creating device that creates a new electronic document, the device comprising:
an obtaining unit that obtains an electronic form containing one or a plurality of variable fields, to each of which a value is to be assigned, and further containing permission information specifying user operation permission with respect to a value to be assigned to each of the variable fields;
an assigning unit that assigns a value to each of the variable fields in the electronic form; and
a prevention processing unit that performs processing to prevent operation by a user who has no permission, based on the permission information, with respect to the value assigned to each of the variable fields.

2. The electronic document creating device according to claim 1, further comprising:
a setting unit that sets security policy information specifying operation permission for the created electronic document, the security policy information being set in association with the treated electronic document and separately from the created electronic document,
wherein the security policy information is set on the basis of security policy information which is associated with the electronic form and specifies operation permission for the electronic form.

3. The electronic document creating device according to claim 2, wherein the setting unit causes inheritance of the security policy information of the electronic form to thereby set the security policy information of the created electronic document.

4. The electronic document creating device according to claim 3, wherein the inheritance is performed in a security policy of the new electronic document by referring to a security policy of the electronic form.

5. The electronic document creating device according to claim 3, wherein the inheritance is performed by storing identifying information of the electronic form in the new electronic document to thereby allow reference to the security policy of the electronic form from the new electronic document.

6. A computer readable storage medium storing a program causing a computer to execute a process for creating a new electronic document, the process comprising:
obtaining an electronic form containing one or a plurality of variable fields, to each of which a value is to be assigned, and further containing permission information specifying user operation permission with respect to a value to be assigned to each of the variable fields;
assigning a value to each of the variable fields in the electronic form; and
performing processing to prevent operation by a user who has no permission, based on the permission information, with respect to the value assigned to each of the variable fields.

7. The storage medium according to claim 6, the process further comprising:
setting security policy information specifying operation permission for the created electronic document, the security policy information being set in association with the created electronic document and separately from the created electronic document,
wherein the security policy information is set on the basis of security policy information which is associated with the electronic form and specifies operation permission for the electronic form.

8. The storage medium according to claim 7, wherein the setting includes causing inheritance of the security policy information of the electronic form to thereby set the security policy information of the created electronic document.

9. The storage medium according to claim 8, wherein the inheritance is performed in a security policy of the new electronic document by referring to a security policy of the electronic form.

10. The storage medium according to claim 8, wherein the inheritance is performed by storing identifying information of the electronic form in the new electronic document to thereby allow reference to the security policy of the electronic form from the new electronic document.

11. A method for creating a new electronic document, the method comprising:
obtaining an electronic form containing one or a plurality of variable fields, to each of which a value is to be assigned, and further containing permission information specifying user operation permission with respect to a value to be assigned to each of the variable fields;
assigning a value to each of the variable fields in the electronic form; and
performing processing to prevent operation by a user who has no permission, based on the permission information, with respect to the value assigned to each of the variable fields.

12. The method according to claim 11, further comprising:
setting security policy information specifying operation permission for the created electronic document, the security policy information being set in association with the created electronic document and separately from the created electronic document,
wherein the security policy information is set on the basis of security policy information which is associated with the electronic form and specifies operation permission for the electronic form.

13. The method according to claim 12, wherein the setting includes causing inheritance of the security policy information of the electronic form to thereby set the security policy information of the created electronic document.

14. The method according to claim 13, wherein the inheritance is performed in a security policy of the new electronic document by referring to a security policy of the electronic form.

15. The method according to claim 13, wherein the inheritance is performed by storing identifying information of the electronic form in the new electronic document to thereby allow reference to the security policy of the electronic form from the new electronic document.

16. A computer readable storage medium storing an electronic form that specifies a format of an electronic document to be created by a computer, the electronic form comprising:
one or a plurality of variable fields, to each of which a value is to be assigned; and
permission information specifying user operation permission with respect to a value to be assigned to each of the variable fields.
